(19) United States
(12) Patent Application Publication
(10) Pub. No.: US 2009/0242432 A1
(43) Pub. Date: Oct. 1, 2009

(54) APPARATUSES AND METHODS FOR DELIVERING FUEL ADDITIVE TO A VEHICLE FUEL TANK

(76) Inventor: James R. Grebe, Fullerton, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/258,354

(22) Filed: Oct. 24, 2008

Related U.S. Application Data
(60) Provisional application No. 60/983,094, filed on Oct. 26, 2007.

(51) Int. Cl. B65D 83/04; B67C 11/00

(52) U.S. Cl. 206/229; 206/469; 206/531; 220/694; 221/1; 221/312 C

(57) ABSTRACT

A package for delivering a fuel additive, such as a pellet, to a fuel tank of a vehicle can comprise a guide member and a storage member. The guide member can be arranged into a generally flat configuration and into a generally channel-shaped or funnel-shaped configuration. The fuel additive can be transferred from the storage member to the guide member, which can direct the fuel additive toward an opening of the fuel tank.

### CROSS-REFERENCE TO RELATED APPLICATION

This application claims the benefit under 35 U.S.C. § 119(e) of U.S. Provisional Application No. 60/983,094, filed Oct. 26, 2007, titled PACKAGING CONFIGURED TO GUIDE A FUEL TREATMENT PELLET INTO A VEHICLE FUEL TANK, the entire contents of which is hereby incorporated by reference herein and made a part of this specification.

### BACKGROUND

1. Field of the Disclosure

The present disclosure relates generally to the field of delivery of fuel additives or treatments to vehicle gas tanks and, in some embodiments, more particularly to the delivery of fuel treatment pellets to vehicle gas tanks.

2. Description of the Related Art

Fuel additives can be introduced to vehicle fuel tanks to treat the fuel contained therein. Some fuel additives are fluids, while others are in pellet form. Fuel additives can be introduced to a fuel tank through an opening and, in some instances, a fuel filler neck that connects the opening to the fuel tank. In liquid form, a container or bottle will often include an elongated neck portion shaped to allow pouring of the liquid fuel additive from the container directly into the opening and/or fuel filler neck of most automobile fuel tanks or cells. A valve may be located at or near the opening and/or in the fuel filler neck to reduce or prevent vapor loss.

### SUMMARY

An aspect of at least one of the embodiments disclosed herein includes the recognition that consumers are generally uncomfortable touching fuel additive pellets. In accordance with at least one of the embodiments disclosed herein, a package for delivering at least one fuel additive pellet to a fuel tank of a vehicle can comprise a collapsible guide member and a pellet storage member.

In at least one embodiment, a package for storing at least one fuel additive pellet and directing the at least one additive pellet to an opening of a fuel tank of a vehicle can comprise a guide member and a storage member. The storage member can be connected to the guide member. The storage member can be positionable relative to the guide member such that the at least one additive pellet is transferable from the storage member onto the guide member without contact between human skin and the at least one fuel additive pellet. The guide member can have a collapsed configuration and an expanded configuration to guide the pellet along a length of the guide member to a desired location.

In at least one embodiment, a method of delivering a fuel additive to a fuel tank can comprise forming a guide member of a package into a guide configuration. At least one unit of fuel additive can be transferred from a storage member of the package to the guide member. The method can further comprise directing the unit of fuel additive along the guide member to an opening of a fuel tank.

### BRIEF DESCRIPTION OF THE DRAWINGS

The above-mentioned and other features of the invention disclosed herein are described below with reference to the drawings of the preferred embodiments. The illustrated embodiments are intended to illustrate, but not limit, the invention. The drawings contain the following figures:

FIG. 1 illustrates an embodiment of a package positioned for delivery of a pellet to a fuel tank of a vehicle during an embodiment of delivery of the pellet to the fuel tank.

FIG. 2 is a front view of the package of FIG. 1 before use thereof.

FIG. 3 is an exploded perspective view of the package of FIG. 1.

FIG. 4 is a perspective view of the package of FIG. 1 having a pellet storage member positioned for ejection of the pellet from the storage member.

FIG. 5 is a perspective view of the package of FIG. 5 additionally having a collapsible guide member configured to guide a pellet along the guide member.

FIG. 6 illustrates another embodiment of a package positioned for delivery of a pellet to a fuel tank of a vehicle during an embodiment of delivery of the pellet to the fuel tank.

FIG. 7 is a front view of the package of FIG. 6.

FIG. 8 is a perspective view of the package of FIG. 6 showing removal of a detachable portion of the package.

FIG. 9 is a perspective view of another embodiment of a package.

### DETAILED DESCRIPTION OF THE PREFERRED EMBODIMENTS

In some of the embodiments of the present disclosure, a packaging includes packaging members that provide a hands-free or at least substantially hands-free delivery of one or more fuel additive pellets from a blister tab or other storage member to an automobile fuel tank. For example, a package for delivery of fuel additive pellets can comprise a collapsible guide member and a pellet storage member. The collapsible guide member can be collapsed to a generally flattened state for storage, transportation, and/or display of the package. The pellet storage member can protect, and in some embodiments preserve one or more fuel additive pellets. In some embodiments, the storage member and the guide member can be movable relative to one another. For example, a storage member may advantageously be movable between an arrangement for storage, transportation, and/or display of the package and another arrangement that facilitates transfer of one or more fuel additive pellets from the storage member to the guide member.

As consumers are generally familiar with the liquid forms of fuel additives being available in a bottle, in some embodiments, the packaging of the fuel additive pellets may advantageously include bottle print indicia and/or bottle-shaped packaging. Bottle print indicia and/or bottle-shaped packaging may serve one or more functions. For example, bottle print indicia and/or bottle shaped packaging can indicate the use of non-liquid fuel additives associated with the packaging in a manner similar to that of liquid forms of fuel additives. Additionally or alternatively, bottle print indicia and/or bottle shaped packaging can signal the ability of the package to be used in a manner similar to a bottle to delivery a fuel additive to a fuel tank.

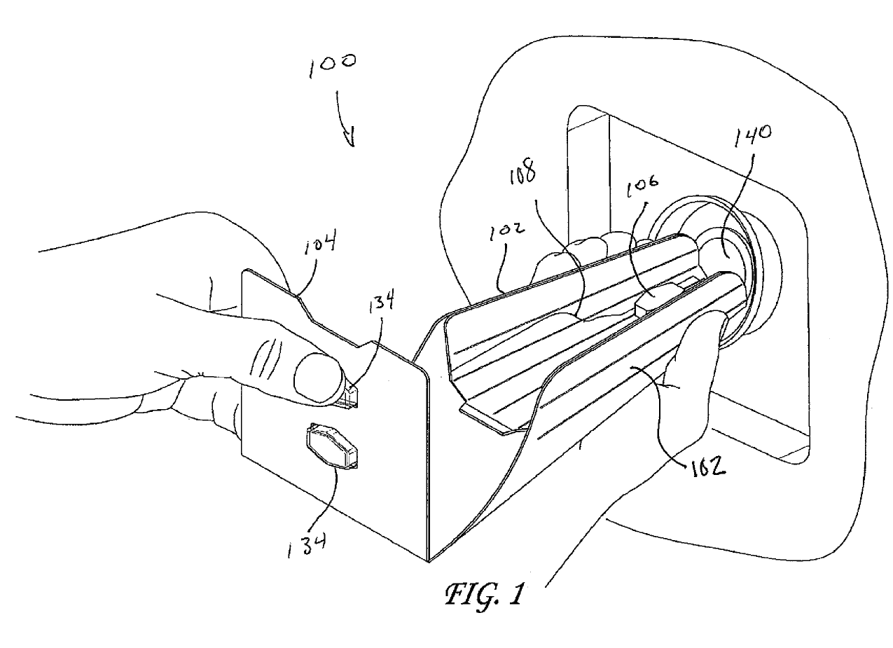

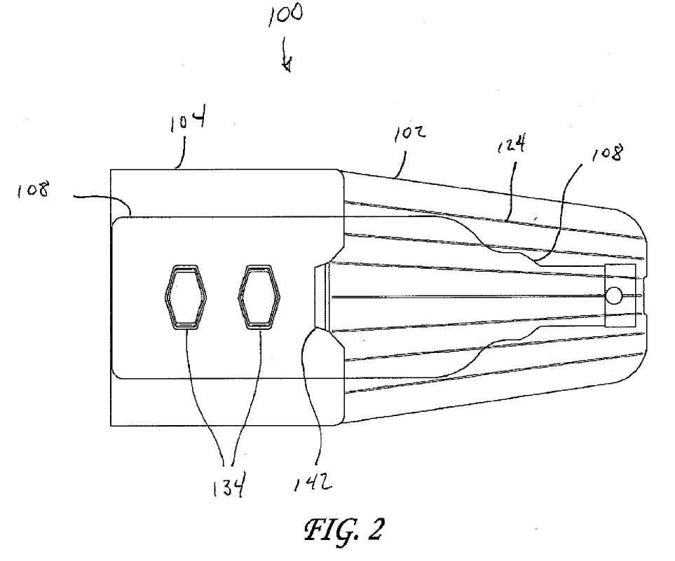

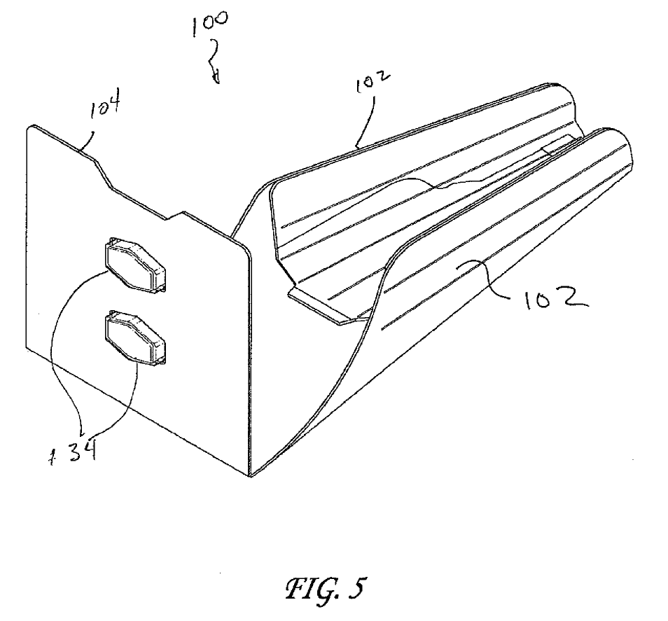

FIGS. 1-5 illustrate a package 100 according to an embodiment. Referring to FIGS. 1 and 2, the package 100 can comprise one or more guide members 102 and a storage member 104. The storage member 104 may include one or more fuel additive pellets 106. In some embodiments, the storage member 104 may include one or more tablets, capsules, or other forms of fuel additive, or other substance. The guide member 102 and the storage member 104 can have bottle-like indicia 108 to indicate the use of the package 100 and pellets 106.

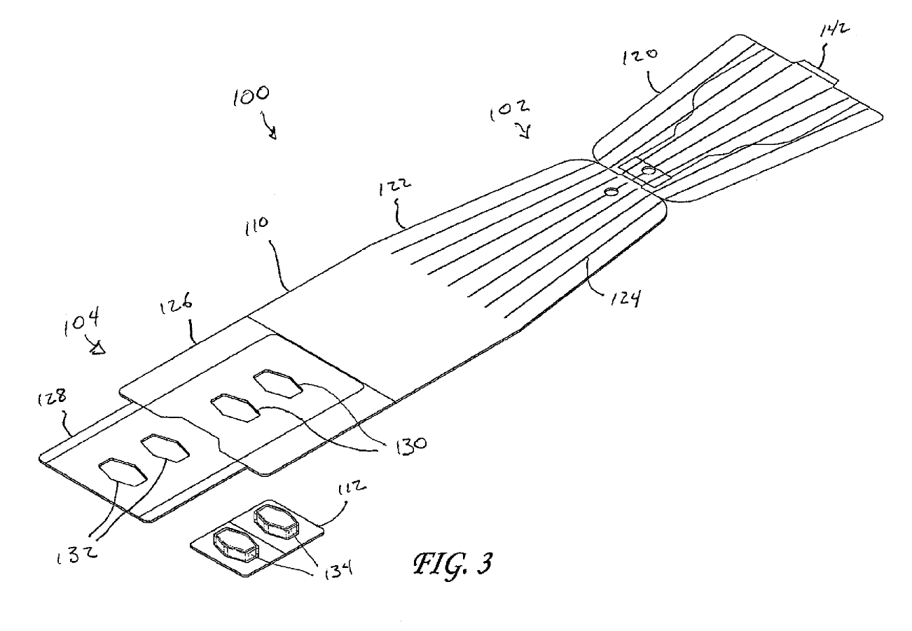

In one embodiment, as shown in FIG. 3, the package 100 can include a sheet 110 and a blister pack 112. The sheet 110 may comprise a paper product, such as cardboard, a plastic, or other material that is sufficiently flexible to allow the guide members 102 to be collapsed into a generally flat condition and bent into a generally channel-shaped configuration, as shown in FIG. 1. The sheet 110 may include scoring to assist a user in flexing and/or shaping the guide members 102.

Referring again to FIG. 3, the guide member 102 can comprise a first portion 120 that can be folded to overlap a second portion 122 of the sheet 110. Alternatively, the guide member 102 can comprise more or fewer than two portions of the sheet 110. The portions 120, 122 can include articulation lines 124, such as indentations, scores, or perforations, to facilitate and control bending of the guide member 102. The articulation lines 124, when included, can comprise regions of the guide member 102 that have a thickness that is greater than or less than the surrounding regions. Each articulation line 124 can be either continuous or discontinuous along its length. Any included articulation line 124 can extend all or a portion of a length of the guide member 102. In an embodiments, the guide member 102 can comprise 8 articulation lines 124, as shown in FIGS. 1-5, or more than or fewer than 8 articulation lines. For example, the guide member 102 can comprise 1, 2, 3, 4, 5, 6, 7, 9, 10, 11, 12 or more articulation lines.

In some embodiments, the guide member 102 can be configured to facilitate opening a valve obstructing access to an automobile fuel tank, such as in a fuel filler neck, for example. For example, the guide member 102 can have a suitable combination of length, rigidity, and distal surface area to reach and open the valve without the user directly contacting the valve.

The storage member 104 can comprise a third portion 126 that can be folded to overlap a fourth portion 128 of the sheet 110. Alternatively, the storage member 104 can comprise more or fewer than two portions of the sheet 110. In some embodiments, the storage member 104 and the guide member 102 can be formed from separate sheets of material.

In some embodiments, the storage member 104 comprises apertures 130 in the third portion 126 and apertures 132 the fourth portion 128. The apertures 130 in the third portion 126 can be arranged to correspond to the blisters 134 of the blister pack 112 such that the blisters 134 can be positioned within the apertures 130. The apertures 132 in the fourth portion 128 can be arranged such that when the fourth portion 128 is folded to overlap the third portion 126 the apertures 132 are positioned in generally alignment with the apertures 130 in the third portion 126, thereby sandwiching the one or more blister packs 112 therebetween. Such a configuration can, in some embodiments, facilitate removal of fuel additives from the blisters 134. For example, the apertures 130 can expose the blisters 134 so that the blisters 134 can be easily crushed to force the fuel additives through a membrane, such as foil, covering the blisters 134. The fuel additives can pass through the apertures 132 as the fuel additives are expelled from the blisters 134 and the membrane is broken.

The third portion 126 and the fourth portion 128 are preferably larger than the blister pack 112. When the blisters 134 are positioned within the apertures 130 the fourth portion 128 can be folded to overlap the third portion 126 and the blister pack 112. The third portion 126 and the fourth portion 128 can be fasted to one another to secure the blister pack 112 between them. The third portion 126 and the fourth portion 128 can be fasted together by adhesive, staples, or other means known to those of skill in the art. In alternative embodiments, the blister pack 112 can be secured to only a single portion of the sheet 110 or can be integrally formed with the sheet 110.

Other configurations of the storage member 104 that do not comprise a blister pack are also contemplated. For example, the storage member 102 can comprise a box or a bag made of plastic, a paper product, or other material.

In some embodiments, the storage member 104 can be folded to overlap the guide member 102, as shown in FIG. 2. The storage member 104 can additionally be positioned under a tab 142 of the guide member 102 to hold the storage member 104 against the guide member 102. Alternatively, the storage member 104 can be held against the guide member 102 by other means known to those of skill in the art, such as adhesives, staples, or other fasteners.

In the embodiment of FIGS. 1-5, the storage member 104 comprises apertures 132 which expose the membrane covering the blister 134. When the storage member 104 is folded to overlap the guide member 102 in the manner illustrated in FIG. 2, the exposed membrane can be protected so as to reduce the possibility that the membrane may be inadvertently broken.

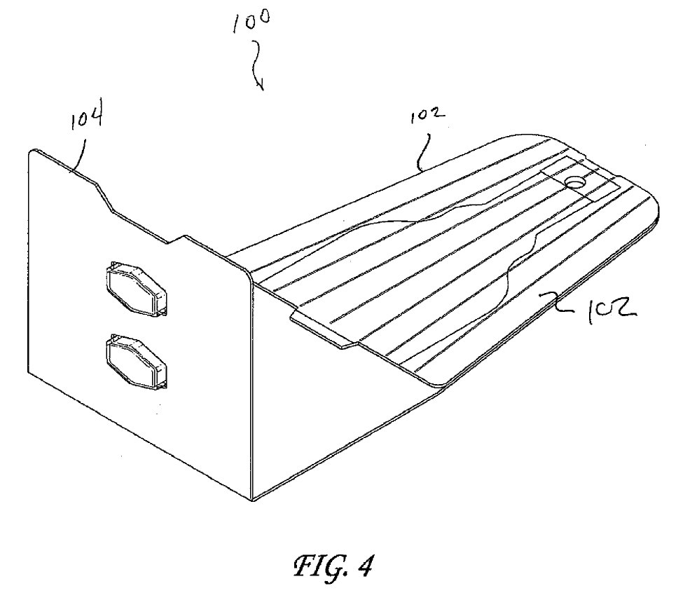

When a user desires to deliver one or more pellets 106, or other forms of fuel additive, from the package 100 to a fuel tank of a vehicle, the user can pull the storage member 104 generally away from the guide member 102, as shown in FIG. 4, for example. In some embodiments, such as the embodiment of FIG. 4, the storage member 104 can remain connected to the guide member 102 after the storage member 104 has been moved generally away form the guide member 102.

The user can deform the guide member 102 into a channel as shown in FIG. 1, for example, and can position the guide member 102 at an opening 140 leading to the fuel tank. If access to the fuel tank is inhibited by a valve, the user can press a distal end of the guide member 102 against the valve to open the valve so the fuel additive can pass through the valve.

The one or more pellets 106 can be delivered to the tank through the opening 140 by transferring one or more pellets 106 from the storage member 104 to the guide member 102, and from the guide member 102 to the opening 140. For example, one or more pellets 106 can be pressed out of the blister 134 through the storage member 104 onto the guide member 102. In embodiments wherein the storage member 104 does not comprise a blister pack 112, the storage member can be opened by an appropriate method and deposited on the guide member 102. Preferably, the fuel additive can be transferred from the storage member 104 to the guide member 102 without contact or at least with reduced contact between the user's skin and the fuel additive.

The user can incline the guide member 102, either before or after ejecting the one or more pellets 106, such that the one or more pellets 106 travel along the guide member 102 into the opening 140 of the fuel tank. Sides of the guide member 102 that form the channel can direct the one or more pellets 106 toward the distal end of the guide member 102.

In embodiments wherein the package 100 contains a plurality of pellets 106, or other forms of fuel additives, one or more pellets 106 can be delivered to the tank while one or more other pellets 106 can be retained in the storage member 104 for use at a later time. For example, in the embodiment of FIGS. 1-5, after one pellet 106 has be delivered through the opening 140, the storage member 104 can be again folded toward the guide member 102 to protect the membrane covering the unopened blister 134 until it is desired to deliver the pellet 106 to a fuel tank. The storage member 104 again can be at least partially positioned beneath the tab 142.

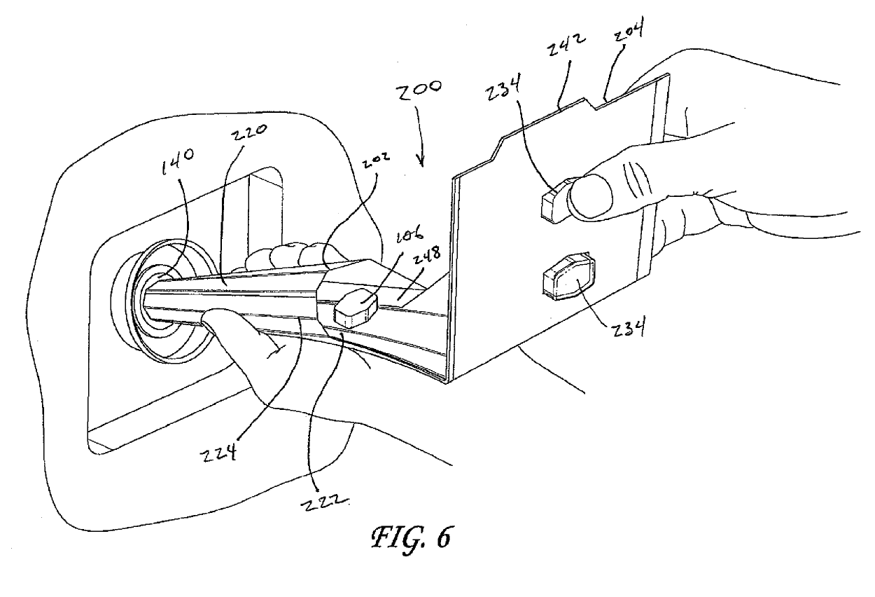

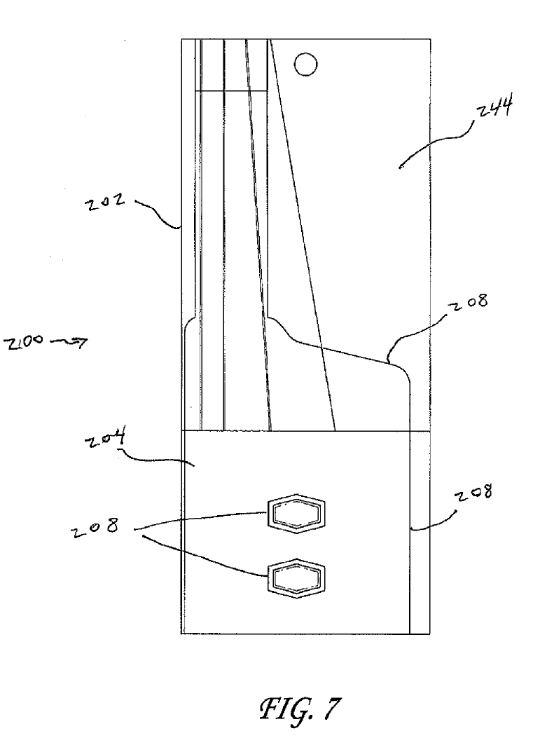

FIGS. 6-8 illustrate a package 200 according to an embodiment. Referring to FIGS. 6 and 7, the package 200 can comprise one or more guide members 202 and a storage member 204. The storage member 204 may include one or more fuel additive pellets 106. In some embodiments, the storage member 104 may include one or more tablets, capsules, or other forms of fuel additive, or other substance. The guide member 202 and the storage member 204 can have bottle-like indicia 208 to indicate the use of the package 200 and pellets 106.

The package 200 can include a sheet 210 and a blister pack. The sheet 210 may comprise a paper product, such as cardboard, a plastic, or other material that is sufficiently flexible to allow the guide member 202 to be collapsed into a generally flat condition and expanded into a generally funnel-shaped or generally tube-shaped condition, as shown in FIG. 6. The sheet 210 may include scoring to assist a user in flexing and/or shaping the guide members 202. In some embodiments, the storage member 204 and the guide member 202 can be formed from separate sheets of material.

With continued reference to FIG. 6, the guide member 202 can comprise a first portion 220 that can be folded to overlap a second portion 222 of the sheet 210. Alternatively, the guide member 202 can comprise more or fewer than two portions of the sheet 210. The portions 220, 222 can include articulation lines 224, as described above, to facilitate and control flexure of the guide member 202. The first portion 220 can be connected to the second portion 222 at a connection tab 248. Like the guide member 102 described above, the guide member 202 can be configured to facilitate opening a valve obstructing access to an automobile fuel tank, such as in a fuel filler neck, for example.

The storage member 204 can be constructed in a similar manner as storage member 104, described above. For example, in some embodiments, the storage member 204 can be configured such that blisters 234 extend through apertures 230 in the storage member 204. Other configurations of the storage number 204 and cannot comprise a blister pack are also contemplated. For example, the storage member 202 can comprise a box or a bag made of plastic, a paper product, or other material.

In some embodiments, the storage member 204 can be folded to overlap the guide member 202, as shown in FIG. 7. The storage member 204 can additionally comprise a tab 242 that can be positioned under the first portion 220 of the guide member 202 to hold the storage member 204 against the guide member 202. Alternatively, the storage member 204 can be held against the guide member 202 by other means known to those of skill in the art, such as adhesives, staples, or other fasteners.

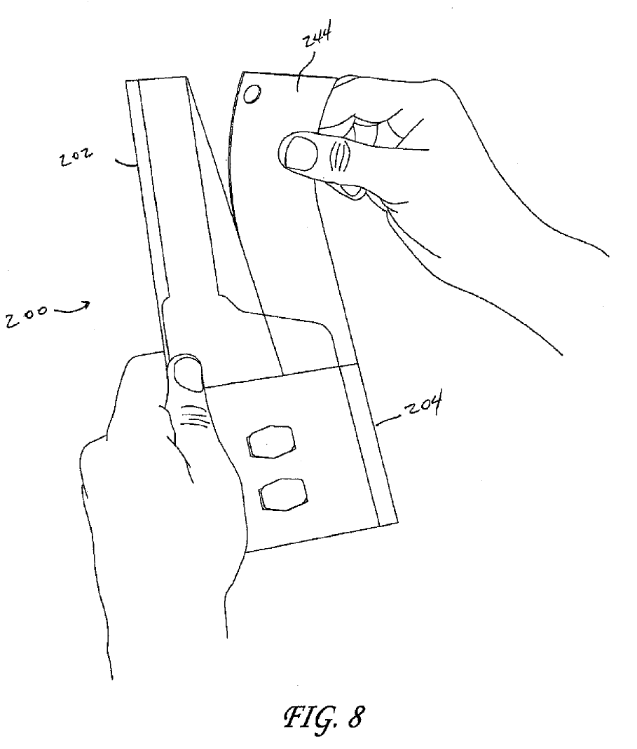

In some embodiments, the guide member 202 can comprise an additional member 244. The additional member 244 can be removable connected to the guide member 202 by a line of weakness 246, such as a perforation. The user can remove the additional member 244 from the guide section 202, as shown in FIG. 8, by tearing along the line of weakness 246.

When a user desires to deliver one or more pellets 106, or other forms a fuel additive, from the package 200 to a fuel tank of a vehicle, the user can pull the storage member 204 generally away from the guide member 202 as shown in FIG. 6, for example. In some embodiments, such as the embodiment of FIG. 6, the storage member 204 can remain connected to the guide member 202 after the storage member 204 has been moved generally away from the guide member 202.

The user can deform the guide member 202 into a funnel or tube shape as shown, for example, in FIG. 6 and can position the guide member 202 at an opening 140 leading to the fuel tank. If access to the fuel tank is inhibited by a valve, the user can press a distal end of the guide number 202 against the valve to open the valve so the fuel additive can pass through the valve.

The one or more pellets 106 can be delivered to the tank through the opening 140 by transferring one or more pellets 106 from the storage member 204 to the guide member 202, and from the guide member 202 to the opening 140. For example, one or more pellets 106 can be pressed out of the blister 234 through the storage member 204 onto the guide member 202. In embodiments wherein the storage member 204 does not comprise a blister pack, the storage member can be opened by an appropriate method and deposited on the guide member 202. Preferably, the fuel additive can be transferred from the storage member 204 to the guide member 202 without contact or at least with reduced contact between the user's skin and the fuel additive.

The user can incline the guide member 202, either before or after ejecting the one or more pellets 106, such that the one or more pellets 106 travel along the guide member 202 into the opening 140 of the fuel tank. The walls of the guide member 202 that form the funnel or tube candidate racked the one or more pellets 106 toward the distal end of the guide number 202.

As with the package 100, in embodiments wherein the package 200 contains a plurality of pellets 106, or other forms of fuel additives, one or more pellets 106 can be delivered to the tank while one or more other pellets 106 can be retained in the storage member 104 for use at a later time.

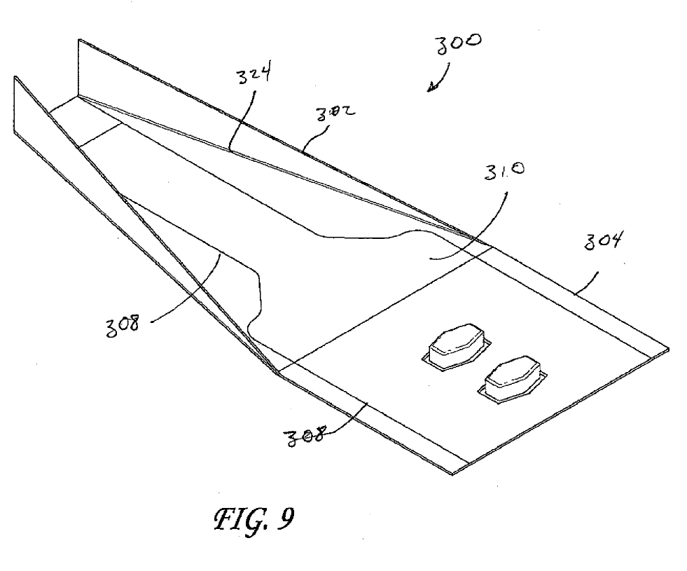

FIG. 9 illustrates a package 300. The package 300 can comprise one or more guide members 302 and a storage member 304. The storage member 304 may include one or more fuel additive pellets 106, or other forms of fuel additive. The guide member 302 and the storage member 304 can have bottle-like indicia 308 to indicate the use of the package 300 and pellets 106.

The package 300 can include a sheet 310 and a blister pack, as described above with regard to packages 100, 200. The guide member 302 and the storage member 304 can be formed from more than one sheet of material in some embodiments. Like the guide member 102, the guide member 302 can include articulation lines 324 to facilitate and control flexure of the guide member 302. The guide member 302 can be bent into a channel as shown in FIG. 9.

The storage member 304 can be constructed in a similar manner as storage members 104, 204, described above, such that blisters 334 extend through apertures 330 in the storage member 304. In other embodiments, the storage member 304 can be constructed without any blister pack. In some embodiments, the storage member 304 can be folded to overlap the guide member 302, as shown in FIG. 9.

The package 300 can be used in a manner similar to that described above with respect to packages 100, 200 to deliver fuel additive to a fuel tank of a vehicle.

Although the invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In addition, while several variations of the invention have been shown and described in detail, other modifications, which are within the scope of the invention, will be readily apparent to those of skill in the art based upon this disclosure. For example, other packaging configurations that allow a pellet to be deposited into a vehicle fuel tank include having portions of the guide member that bend, flex, fold, or otherwise articulate on either or both of the sides of the guide member to generally form a channel or funnel comprising one or a plurality of portions, sides, or surfaces that guide a pellet into a fuel tank. The one or a plurality of portions, sides, or surfaces may be fixed to one another by integral formation, adhesives, staples, or other fasteners. For example, one portion may be folded over another side and fastened together along a portion of the portions, two portions of a single sheet may be folded over a third and fasted to each other or the third portion, or a portion can be fastened to one or more separate portions.

It is also contemplated that various combinations or sub-combinations of the specific features and aspects of the embodiments may be made and still fall within the scope of the invention. It should be understood that various features and aspects of the disclosed embodiments can be combined with or substituted for one another in order to form varying modes of the disclosed invention. Thus, it is intended that the scope of at least some of the embodiments of the present invention herein described should not be limited by the particular disclosed embodiments described above.

What is claimed is:

1. A package for storing at least one fuel additive pellet and directing the at least one additive pellet to an opening of a fuel tank of a vehicle, the package comprising a guide member and a storage member, the guide member having a collapsed configuration and an expanded configuration to guide the pellet along a length of the guide member to a desired location, the expanded configuration of the guide member generally forming a channel, the storage member being positionable relative to the guide member such that the at least one additive pellet can be transferable from the storage member onto the guide member with reduced contact between human skin and the at least one fuel additive pellet.

2. The package of claim 1, wherein the storage member is operably connected to the guide member when the storage member is positioned relative to the guide member for transfer of the at least one additive pellet onto the guide member with reduced contact between human skin and the at least one fuel additive pellet.

3. The package of claim 1, wherein the storage member and the guide member are configured such that at least a portion of the storage member is detached from at least a portion of the guide member when the storage member is positioned relative to the guide member for transfer of the at least one additive pellet onto the guide member with reduced contact between human skin and the at least one fuel additive pellet.

4. The package of claim 1, wherein the guide member comprises a paper product.

5. The package of claim 4, wherein the guide member comprises cardboard.

6. The package of claim 1, wherein the guide member further comprises articulation lines.

7. The package of claim 1, wherein the guide member comprises sufficiently rigid material to push open a door positioned in an opening of a fuel tank of a vehicle.

8. A method of delivering a fuel additive to a fuel tank, comprising:
forming a guide member of a package into a channel;
transferring at least one unit of fuel additive from a storage member of the package to the guide member;
directing the unit of fuel additive along the guide member to an opening of a fuel tank.

9. The method of claim 8, wherein the transferring the at least one unit of fuel additive comprises transferring from the storage member of the package to the guide member with reduced contact with human skin.

10. The method of claim 9, wherein the transferring the at least one unit of fuel additive comprises transferring from the storage member of the package to the guide member without contact with human skin.

11. The method of claim 9, comprising moving the storage member of the package relative to the guide member of the package prior to transferring the at least one unit of fuel additive from the storage member to the guide member.

12. The method of claim 11, comprising detaching at least a portion of a storage member of a package from at least a portion of a guide member of the package.

13. The method of claim 8, comprising transferring at least one additional unit of fuel additive from the storage member to the guide member.

14. The method of claim 8, comprising pressing the guide member against a door in an opening of the fuel tank to at least partially open the door.
